(19) United States
(12) Patent Application Publication
(10) Pub. No.: US 2020/0402090 A1
(43) Pub. Date: Dec. 24, 2020

(54) SYSTEM AND METHOD FOR PROVIDING INCENTIVES FOR REFERRALS

(71) Applicants: Scott Allan Northmore, Bracebridge, CA (US); Bruce Walter Clark, Gravenhurst, CA (US); Wilson Blake Cronyn, Toronto, CA (US)

(72) Inventors: Scott Allan Northmore, Bracebridge, CA (US); Bruce Walter Clark, Gravenhurst, CA (US); Wilson Blake Cronyn, Toronto, CA (US)

(21) Appl. No.: 15/789,556

(22) Filed: Oct. 20, 2017

(51) Int. Cl. G06Q 30/02; G06Q 50/00; G06F 16/955

(52) U.S. Cl. CPC G06Q 30/0214; G06Q 30/0277; G06Q 30/0215; G06Q 30/0226; G06F 16/9558; G06Q 50/01; G06Q 30/0238; G06Q 30/0235; G06Q 30/0224

(57) ABSTRACT

An internet based software system that provides a method of creating referrals of consumer products, events and services, to enable users in the system to electronically refer products to other users and obtain rewards when referred purchases are made. These rewards can be in the form of actual local currency, merchandise, or a Points system with a currency valuation. The system consists of sending unique links over email, social media, or websites to communicate referrals to others. The system tracks each click and stores unique identifiers for each referral response. The system also consists of special plugins that are installed on third-party websites to track the purchases that have come from user referrals. Upon purchase, the communication transactions are analyzed, and rewards are given out to each user that has a referral link recorded from the purchaser.

### RELATED APPLICATION

This application claims priority to U.S. Provisional Patent Application No. 62/411,861, which was filed Oct. 24, 2016 and is incorporated herein by reference.

### BACKGROUND

### Field of the Invention

The present invention relates to systems and method for providing incentives for referral marketing programs.

### Description of the Related Art

Currently loyalty systems reward a purchaser by providing discounts or other incentives for returning for subsequent purchases. Referral marketing systems typically operate on a coupon or simple points based system where the act of referring an additional client provides a direct benefit to the referrer, such as a discount, cash rebate, points that can be exchanged for rewards, or similar. Such incentives can be in paper form or electronic form.

This process while partially effective, suffers from certain limitations. Specifically, the referrer only gets rewarded for those additional customers that they can directly contact, thus limiting the effectiveness of the reward system to a smaller number of people. In addition, there is no incentive for people receiving a product referral to forward the referral on to further potential customers, thus limiting the audience and impact to referrals.

What is needed is a new method of generating and distributing product referrals such that the incentive to refer to additional people is maintained.

### SUMMARY

A system is disclosed that utilizes and modifies an operational database that provides a method of creating referrals that enable users in the system to refer products to other users and obtain rewards. These rewards can be in the form of actual local currency, merchandise, or a Points system with a currency valuation. In the case of a Points system, these Points are earned by users when they participate by referring products or by purchasing products from a referral.

In one embodiment, the system is referred to as the Broadcast Referral Tracking System (BRTS), and involves tracking and interface elements associated with product pages of vendor commerce sites. In one embodiment, these sites are preferably online retail sites, but this system can also be used for promotion of other product offering systems.

Information is encoded in the product page to uniquely identify the particular product being offered, as well as mechanisms to refer others to this particular product being offered. A system wide tracking system records each referral, and tracks the progress of subsequent referrals, creating a referral chain. If the referral chain ultimately results in a purchase of the product, then all participants in the referral chains that generated the purchase are rewarded according to an algorithm. In one embodiment, the rewards are given in the Points currency, rBux. rBux can then be redeemed at retailers who participate in the promotional system to purchase or discount products.

Another aspect of the current invention involves the transaction processing from the vendor's perspective. The vendor creates unique identifiers for each of their offered products, and provides the mechanism for users to refer the product, enabling the referral chain. When the referral chain generates a successful purchase, the vendor is required to pay a commission fee to the BTRS which is used to support the purchase of products or offering of product discounts with rBux. When a user redeems all or a portion of their points for products, the vendor is compensated by the BRTS with money received from commission fees.

### BRIEF DESCRIPTION OF THE DRAWINGS

In order that the subject matter may be readily understood, embodiments are illustrated by way of examples in the accompanying drawings, in which:

FIG. 1 shows a diagram of the referral propagation process;

FIG. 2 shows a simplified flowchart of the referral tracking process;

FIG. 3 shows a simplified flow chart for the redemption tracking process;

FIG. 4 shows a diagram of the chronological redemption weightings;

FIG. 5 shows a simplified system diagram;

FIG. 6 shows a chart of redemption weightings for the Broadcast Referral Tracking System reward structure.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

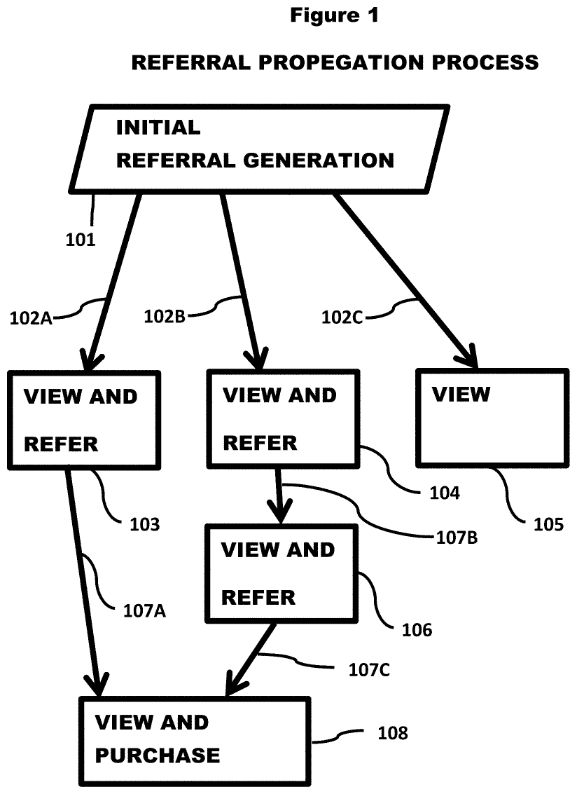

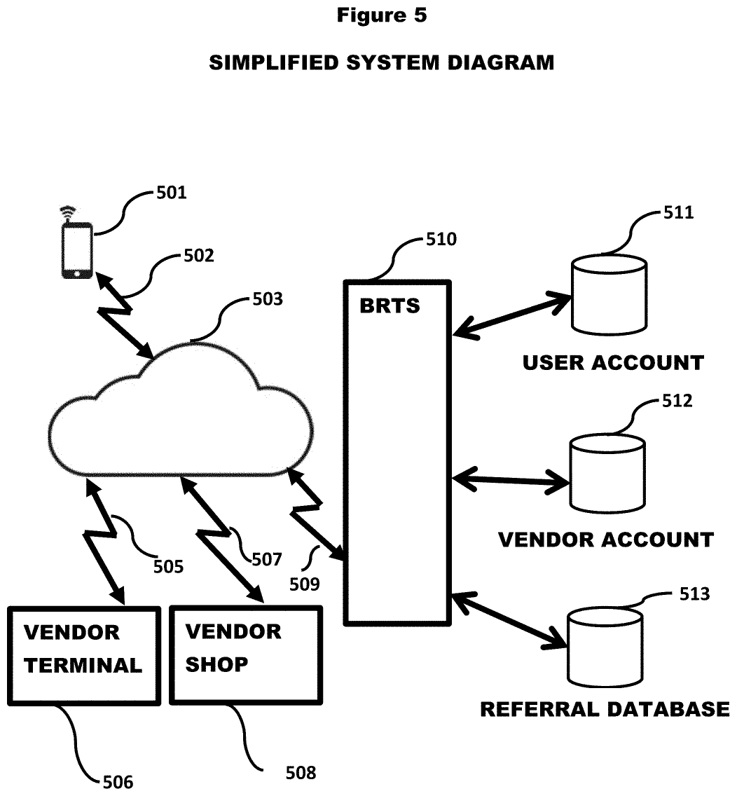

FIG. 1 shows a simplified logical flow diagram of the referral propagation process. In this example, an initial referral generation 101 is created by a user visiting a vendor's product information page, typically at an online retailer's store front or shop. The code for the vendor's product information page is contained in the vendor shop, indicated in FIG. 5, 508. In this example, the initial referral may preferably be created by use of an action button, in this case a ‘refer’ button The referral button initiates the creation of a referral chain. The referral chain information is created including unique user identification, vendor and vendor product information, and referral comments. This data is transmitted via an information packet to the BRTS server and stored in the BRTS system for further processing.

The referral can then be shared through additional mechanisms, including to other users of the BRTS system, or through electronic messaging such as e-mail, Facebook postings or social media. These shared referrals are illustrated as arrows 102A, 102B, and 102C. At element 103, a second user views the referral message that was sent from the initial referrer. User 103 does not act on the referral to purchase the product, but instead, resends the product referral 107A to user 108, who views the referrals and purchases the product.

At 103, 104, 105, and 106, the BRTS system is sent information about each new user that responds to the referral by logging their viewing as part of the referral response chain. User 105 does not forward the referral or purchase the product, and as such is ineligible for rewards in this reward chain. User 104 views and forwards the referral 107B to user 106. User 106 also forwards the referral 107C to user 108 who purchases the product. Note that there is only one purchased product in this illustrative example, but the purchaser has received two referrals for this product. The information regarding each initial referral, viewing of the product and purchase is recorded in the BRTS database, so that accurate information regarding which users were involved in successful purchase chains can be reconstructed for awarding rBux.

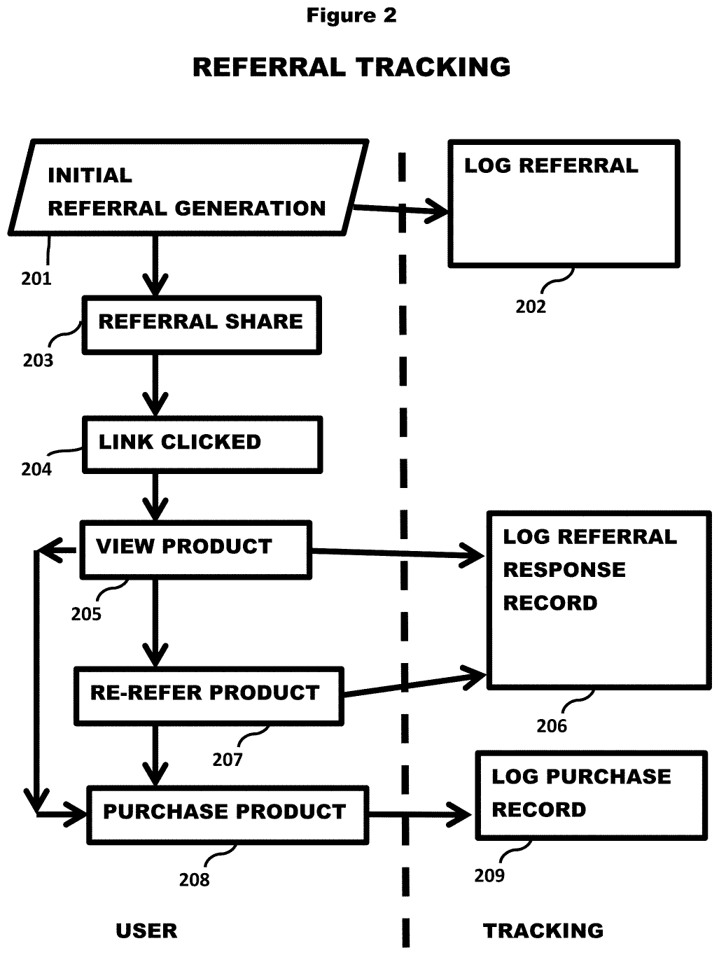

FIG. 2 shows a simplified flow chart of the referral tracking process. The figure is split with a vertical dotted line where the left side is labeled USER, and the right side is labeled TRACKING. Items on the tracking side are actions relating to collection of information by the BRTS system. Items on the left hand side are actions relating to actions performed in the user's terminal. A user generates an initial referral 201. To generate a referral, a user must find a product that they wish to refer. In the preferred embodiment, finding a product can be accomplished by browsing products inside the BRTS system or browsing products at a vendor's web site and selecting the ‘refer’ function or button.

The BRTS system will ascertain the user's unique identification by either using an identifying file on the user's computer, such as a ‘cookie’, an industry standard technique for identifying users on computers, or directing the user to the BRTS system where they can log in and thus identify themselves. Each user's account information is stored in a database in the BRTS system, including information regarding their unique identification, their accumulated rBux rewards, and personal and demographic information collected for market research. Regardless of the method of identification, the user's unique identification information is coupled with the vendor's identification and the specific product identification information, and time of referral generation into a referral record and stored in the BRTS system. In one example, industry standard database servers are used to store the records, and the information is transmitted from code running on the user's computer's web browser associated with the product page. The referral record information is preferably transmitted through an internet connection FIG. 5, 503 using a protocol such as TCP/IP, although a wide variety of protocols and connection methods would also be suitable. The referral record 202 is thus recorded on the BRTS server.

In a further aspect, the initial referral may then be shared to other users, indicated by referral share 203. The referral share information can be sent freely in messages, including e-mail, social media, and directly through the BRTS system. Each referral contains a unique identifier that is used to identify the referral record recorded in 202. If the second user clicks on the link 204, thus expressing interest in the product, the user's browser is directed to a viewing location such as a web page, where more information about the product and the referral can be obtained. The action of viewing the product 205 initiates the creation of a second record, a referral response record 206.

After the user has viewed the product at 205 the user may elect to re-refer the product 207. Facility is provided by means of a control such as a button on the product viewing page to initiate the sending of this re-referral. The re-referral is also logged as a referral response record at 206. This logging of re-referrals enables the BRTS system to track each of the participants in a referral chain, so that participants in each chain that results in a product purchase can be rewarded. Step 207 of re-referring the product may happen multiple times, not shown in FIG. 2 for simplicity.

A referral chain may terminate with the purchase of the referred product 208. This purchase 208 would be initiated from a button or similar control on the vendor's product page. Purchasing the product initiates the logging of a purchase record 209. The complete successful tracking record consists of the initial referral record 202, one or more referral response records 206, and a purchase record 209. This complete tracking record is subsequently used to calculate reward entitlements to each participant in the purchasing chain.

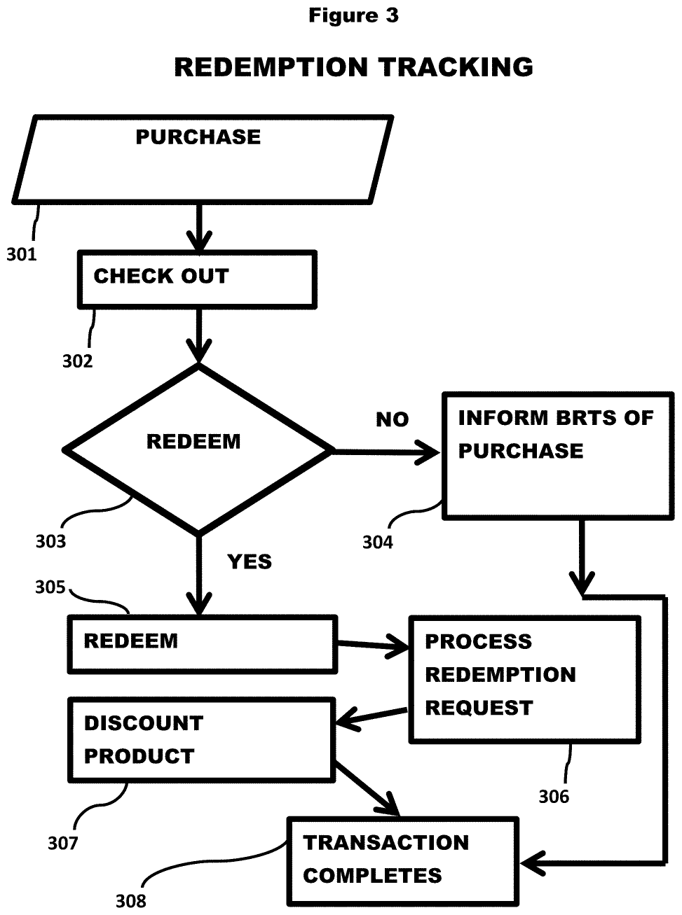

FIG. 3 is a flow chart depicting the steps involved in processing an rBux redemption for a purchase discount. In this embodiment, a user initiating a purchase 301 initiates the possibility of using rBux to discount the purchase. After selecting a purchase, an on-line vendor commonly supports a check out feature 302. This check out feature typically is implemented as a purchase confirmation screen, where the details of all pending purchases are displayed and totalled. The BRTS system adds an additional facility to this buyer confirmation screen by providing code to the online vendor to insert into their purchase confirmation screen. The user observes part of the function of this code as an option to redeem all or a portion of their rBux for a discount, in this implementation, as a ‘redeem’ button 303. If the ‘redeem’ option is not selected, the purchase is logged as a purchase 304 to the BRTS system, so that credit for any referrals can be appropriately processed. After informing the BRTS system in 304, the transaction can proceed to normal completion 308.

If a redemption 303 is requested, code included in the vendor's web page processes the redemption request 306 in conjunction with the BRTS host system. Specifically, a request is sent from the vendor's web page to the BRTS system requesting that the user's account be interrogated for having sufficient rBux to complete the request and on success, debit the user's account. If the redemption request is successful, the code in the vendor's web page applies the associated discount to the product, 307. The customer transaction on the vendor's web page can proceed normally 308.

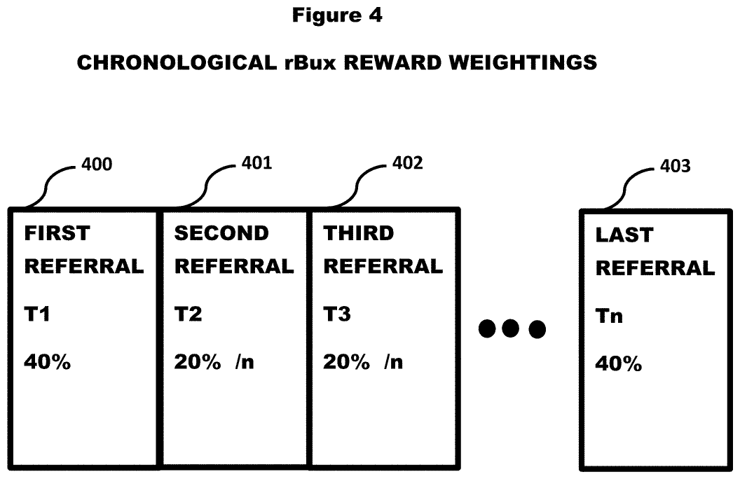

FIG. 4 is a representation of the method of applying rBux rewards to a successful referral chain. Referral chains are initiated by a first referral 400 occuring at time T1. One method of initiating a first referral is by a rBux user to browse available rBux rewardable products on the rBux website. Selecting one of these products as a referral prompts the user to select a method of distributing the referral. The method of distribution can be some combination of: a list of email addresses, a list of other rBux users, a social media post like Facebook or Twitter, or any other messaging or social media distribution.

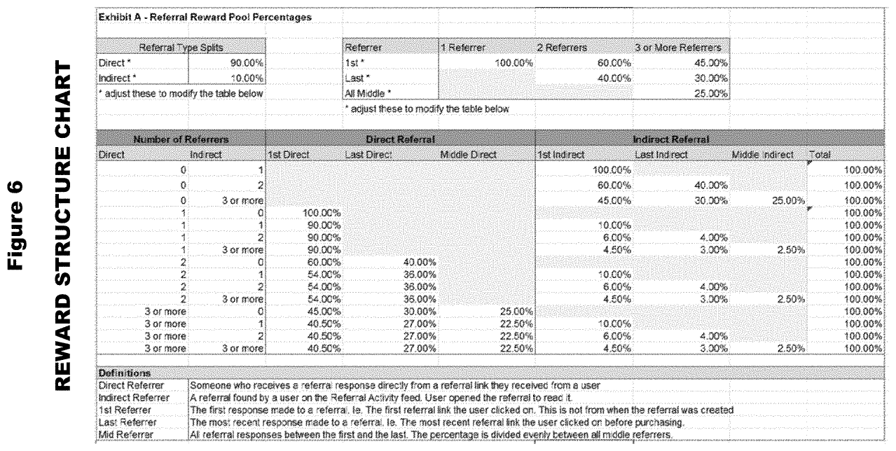

Each referral that is in the path between a first referral 400 and a last referral 403 is considered an intermediate referral, for example in 401 and 402. Intermediate referrals are rewarded differently than the initial referral 400 and the final referral 403. In one example, the intermediate referrals are rewarded with rBux with percentages of the total rBux reward as shown in the reward structure chart in FIG. 6.

FIG. 5 is a simplified system diagram illustrating the hardware and system components of the BRTS system. The core of the BRTS system is the BRTS server that is a program loaded into the execution memory of a server computer and operationally configured to access information databases including user account 511, vendor account 512, and referral database 513. The server is further operationally connected to a data communication network 503 via data connection 509. This data communication network could be of many types, but would preferably be a data communication network such as the Internet.

The data communication network is further connected to a user terminal 501 via network connection 502. Network connection 502 could be one of several types, including mobile cellular data connection, TCP/IP connection through a modem, or other type. The user terminal 501 could be a mobile terminal such as a smartphone, personal computer or other such device that is capable of displaying web pages and executing the scripts therein. These scripts are executed as part of the BRTS system to perform tasks such as generating referrals FIG. 1, 101 and purchasing products FIG. 1, 108.

Other parts of the BRTS system include a vendor terminal 506 operably linked to the data communication network 503. This vendor terminal 506 could be a terminal such as a personal computer or other such device that is capable of displaying web pages and executing the scripts therein. The vendor terminal configures elements of the BRTS system that are unique to that particular vendor, including configuring the system referral information on the vendor's web pages and monitoring their rBux redemption account. An additional element of the BRTS system is the vendor shop 508. The vendor shop is operably linked to the data communication network 503. The vendor shop is the retail point of presence for the vendor, and is the host for the vendor's web pages that offer products or services. In the rBux system, these web pages also include scripts that are served to user terminals 501. These scripts perform the functions of referral generation FIG. 1, 101, and FIG. 2, 201 and initiating functions such as logging referrals FIG. 2, 202, logging referral response records FIG. 2, 206 and logging purchase records FIG. 2, 209.

FIG. 6 is a reward structure chart. This chart indicates preferred weightings for the reward distribution in several cases. For example, the chart indicates rBux reward distributions that vary depending on the source of the referral (direct or indirect), the position in the referral chain of each participant (First, Middle, or Last) and the number of participants in each category. While this is a preferred method of distributing rBux rewards, it is readily apparent that there are many different specific algorithms for relative distribution of rBux rewards inside a referral chain. One other such method is suggested in FIG. 4, where the first referral 400 is apportioned a percentage, in this case 40%, the last referral 403 is apportioned 40%, and all intermediate referrals in the chain (401, 402) are apportioned a total of 20%.

It is important to note that there are other possible configurations of reward chains, as each purchaser FIG. 1, 108 can have been referred the product multiple times before ultimately purchasing the product. One possibility is shown in FIG. 1, where there are two successful referral chains, one through element 103, and one through elements 104 and 106. Using the reward system shown in FIG. 4, and referring to the elements in FIG. 1, 101 is the sole first referral generator (400), 103 and 106 are both last referral generators (403) and 104 is an intermediate referral generator. According to the scheme of FIG. 4, the total rBux reward for that purchase transaction would be divided into the percentages allocated for each classification (first referral, intermediate referral, and last referral) and then further divided equally among the members of each classification.

As an illustrative example of one embodiment, Person X is browsing a vendor's website W and discovers a new type of training shoe that is particularly appealing to them. Person X may consider purchasing the shoe through the vendor's site immediately through the use of a ‘buy now’ selection button or similar. Person Y may also consider that he knows one of his friends who may also be a good match for the shoe, and suspects that they may not know about it yet. Person X has the option of selecting a ‘refer’ button on vendor W's website. By selecting the ‘refer’ option, Person X opens up a referral page that allows them to specify the product they are referring, who they are referring the product to, and additional messaging about the product. By sending this referral, for example to Person Y, a referral response chain is created. The referral response chain can be of a finite duration, normally set by the vendor, in this case vendor W.

Person Y now will receive the referral, and may purchase the product thus creating a successful referral chain. The referral chain transactions (the referral generation, the referral receipt, and the referral purchase) are recorded and the associated rewards are added to the accounts of Person X and Person Y. Alternatively, Person X may not choose to purchase the product, but may decide to forward the referral on to Person Z. If Person Z decides to purchase the product, the referral chain transactions for Persons X, Y, and Z are all recorded, and the associated rewards are added to the accounts of Persons X, Y, and Z. In this example, 40% of the reward is allocated to the referral generator and to the purchaser, and 20% is allocated to all of the other participants in a successful chain. If vendor W had allocated 10 rBux as a reward for the sale, Person X would receive 4 rBux, Person Y would receive 2 rBux, and Person Z would receive 4 rBux.

In another embodiment, referrals can be initiated by online advertising links, audible or inaudible tones broadcast via website, radio, or TV, or bluetooth or Wifi wireless transfer, to the user device. These links are associated with referral records that can then be tracked to purchase or via communications through the referral chain.

While the Applicant's teachings described herein are in conjunction with various embodiments for illustrative purposes, it is not intended that the applicant's teachings be limited to such embodiments. On the contrary, the applicant's teachings described and illustrated herein encompass various alternatives, modifications, and equivalents, without departing from the embodiments, the general scope of which is defined in the appended claims. [31] Except to the extent necessary or inherent in the processes themselves, no particular order to steps or stages of methods or processes described in this disclosure is intended or implied. In many cases the order of process steps may be varied without changing the purpose, effect, or import of the methods described.

We claim:

1. A system for rewarding referral based promotion of products or services comprising the steps of:
creating a unique identifier for a referral;
tracking the progress of the referral though one or more re-referrals in a referral response chain; and
rewarding the participants in successful referral response chains.

2. The system in claim 1, whereby the referral chain is initiated from a control such as a ‘Refer button’ on a vendor's web page or mobile app, or an online advertising link, audible or inaudible tone broadcast via website, radio, or TV, or bluetooth or Wifi wireless transfer.

3. The system in claim 1, where the rewards to participants in successful response chains are at least one of: monetary, purchase credit, purchase discount, or affinity points.

4. The system in claim 1, where the tracking information for identifying participants in the referral response chain is at least in part accomplished by the use of tracking files or ‘cookies’.

5. The system in claim 1, where the referral mechanism is through posts in social media or through electronic messaging.

6. The system in claim 1, where the rewards are differentially allocated so as to provide additional incentives for both the first and last links in the referral response chain.

7. The system in claim 1, where the rewards that a participant earns can be redeemed as discounts at a point of purchase for a participating vendor.

8. A method of creating a referral based promotion of products or services where each participant in a referral response chain is incented to continue the referral response chain whereby:
a unique identifier is created for each referral;
the progress of each referral in the chain is tracked with referral response records; and
participants in successful referral chains are rewarded.

9. The system in claim 8, whereby the referral response record is stored in a central database accessible to referral response chain tracking elements.

10. The system in claim 8, where the rewards to participants in successful response chains are at least one of: monetary, purchase credit, purchase discount, or affinity points.

11. The system in claim 8, where the tracking information for identifying participants in the referral response chain is at least in part accomplished by the use of tracking files or ‘cookies’.

12. The system in claim 8, where the referral mechanism is through posts in social media or through electronic messaging.

13. The system in claim 8, where the rewards are differentially allocated so as to provide additional incentives for both the first and last links in the referral response chain.

14. The system in claim 8, where the rewards that a participant earns can be redeemed as discounts at a point of purchase for a participating vendor.

15. The system in claim 8, where the referral response chain is time limited and expires at a pre-set or vendor selectable time limit.

16. A method of increasing advertising efficiency by encouraging the viral distribution of advertising messages by providing a tracking system for each step in a viral distribution tree;
monitoring the progress of each referral event;
recording the referral tree data in a data server;
calculating the portion of the total reward per participant for a successful referral response chain; and
rewarding the participants with proportional rewards.

17. The system in claim 16, where the rewards are differentially allocated so as to provide additional incentives for both the first and last links in the referral response chain.

18. The system in claim 16, where the reward structure charts can be modified by the vendor to further optimize the incentive effectiveness.

19. The system in claim 16, where the referral chain is initiated from a ‘refer’ button on the vendor's web page or mobile app, or an online advertising link, audible or inaudible tone broadcast via website, radio, or TV, or bluetooth or Wifi wireless transfer.

20. The system in claim 16, where the referral response chain is time limited and expires at a pre-set or vendor selectable time limit.
